(19) United States
(12) Patent Application Publication
(10) Pub. No.: US 2010/0211992 A1
(43) Pub. Date: Aug. 19, 2010

(54) DATA SECURITY APPARATUS

(75) Inventors: Yong Tae Cho, Seoul (KR); Kyoung Mu Ryu, Seoul (KR)

Correspondence Address: CHRISTOPHER PAUL MITCHELL, 888 16TH ST., NW, SUITE 800, WASHINGTON, DC, 20006, US

(73) Assignee: MILLENNIUM FORCE CO. LTD, Seongnam-si, Gyeonggi-do (KR)

(21) Appl. No.: 12/678,290

(22) PCT Filed: Sep. 12, 2008
(86) PCT No.: PCT/KR08/05436

§ 371 Date: Mar. 15, 2010

(30) Foreign Application Priority Data
Sep. 14, 2007 (KR) 10-2007-0093449

(51) Int. Cl. G06F 15/16; G06F 21/00

(52) U.S. Cl. 726/3; 726/26; 726/2

(57) ABSTRACT

A data security apparatus fragments original data into a plurality of data, blocks the fragmented data, and distributes and stores the blocked data over and in respective storage medium. The data security apparatus includes a storage having a first block, into which original data of a file is fragmented and blocked, distributed and stored, a security storage medium having a second block, into which the original data is fragmented and blocked, distributed and stored, and a distributed storage management module performing data interface among the storage, the security medium, and an operating system (OS) system, fragmenting and blocking the original data, and distributing and storing the blocked data over and in the storage and the security storage medium.

### TECHNICAL FIELD

The present invention relates to a data security apparatus.

### BACKGROUND ART

Security of a computer system requires integrity and confidentiality of data. The data integrity refers to preventing data from being changed (added, deleted, modified, etc.) by an unauthorized user or execution of an unauthorized application, and the data confidentiality refers to interrupting an unauthorized user from accessing data.

Security is of universal interest to computer users. Computer viruses such as Trojan horse, worms, identifier theft, theft of software and media contents, blackmail using data destruction threats, illegal data release caused by insiders, etc. are prevailing. OS systems provide various security functions for defending these attacks. For example, the recent OS systems and various applications have reinforced security functions of, for instance, encrypting data to store it in a memory.

In particular, due to the development of computer technologies, a high priority is placed on maintaining security of networks. Since dependency on the networks continues to increase, it is more important to protect digital assets in the networks. For example, if a malicious hacker obtains authority to access the network, and then attempts to destroy/change confidential data in the network, considerable damage will occur. Further, in the case in which any internal user releases or attempts to release data on purpose, an existing security system fails to provide an effective solution. In effect, there have been developed numerous security mechanisms for standing against attacks of the data existing on the networks and protecting the internal users from releasing information on purpose.

However, a progress, associated with the internal attacks of the networks has not been made yet. For example, any discontented employee can gain access to an entire network (including a part of the network irrelevant to affairs of the employee). Further, when a typical internal network uses a dynamically allocated IP address, an arbitrary individual can gain access to a network port using another data communication device, thereby having perfect network access.

In addition, a part of the internal network can be provided with authenticating means, Thereby, only a person aware of the authenticating means (e.g. password) is allowed to access the part of the internal network. However, this authenticating means is vulnerable to threats, so it can be easily hacked by the hacker.

### DISCLOSURE

### [Technical Problem]

The present invention has been made to solve the foregoing problems with the prior art, and therefore embodiments of the present invention provide a data security apparatus capable of distributing and storing data to prevent computer hacking, and preventing illegal data release caused by an internal user regardless of whether unintentional or intentional.

### [Technical Solution]

According to an embodiment of the present invention, the data security apparatus comprises: a storage in which a first block of fragmented original data is distributed and stored; a security storage medium in which a second block of the fragmented original data is distributed and stored; and a distributed storage management module performing data interface among the storage, the security medium, and an operating system, fragmenting and blocking the original data, and distributing and storing the blocked data over and in the storage and the security storage medium.

According to another embodiment of the present invention, the storage may include: a public storage that is accessible only with system authentication of the operating system; and a private storage that is accessible only after separate authentication is individually performed by an authentication key.

According to another embodiment of the present invention, the distributed storage management module may destroy the data in the security storage medium in hardware or software fashion, when given conditions including at least one of content theft and illegal data release are met.

According to another embodiment of the present invention, the security storage medium may disable a user to be directly accessed to perform the data interface.

According to another embodiment of the present invention, the public storage and the security storage medium may be distributed in a computer system or over a network.

According to another embodiment of the present invention, the original data may be fragmented into randomly well structured data into at least two blocks, which are distributed over and stored in the public and security storage medium.

According to another embodiment of the present invention, the original data may include a body part, as actual data of a file, and an operation key, containing information about the file.

According to another embodiment of the present invention, the body may be fragmented into randomly well structured data into different body blocks, which are distributed over and stored in the storage and the security storage medium, and the operation key is fragmented into randomly well structured operational key into operation key blocks, which are distributed over and stored in the public and security storage medium.

According to another embodiment of the present invention, authentication information for authenticating a user with respect to the corresponding file may be fragmented into numerous pieces of authentication information, so as to randomly well structured authentication information blocks, which are distributed over and stored in the public and security storage medium.

According to another embodiment of the present invention, the file contained in the operation key may include information about filename extension, creator, type; date created and modified size, and attributes thereof, and authentication information for calling authentication information for authenticating a user with respect to the corresponding file.

According to another embodiment of the present invention, the authentication information may include environment information about the storage, environment information about the system, environment information about work environment, environment information about the file itself, environment information for identifying a user.

According to another embodiment of the present invention, the security storage medium may further include a grab and union instructions having storage path, storage location, and fusion instructions of each block when the file was blocked and is distributed and stored in the public and security storage medium.

According to another embodiment of the present invention, the distributed storage management module may execute the grab and union instruction, when the file is called so as to fuse the related fragmented data and stored in the public and security storage medium and recover the original data from the fragmented data.

According to another embodiment of the present invention, the data in each block may be shifted by a predetermined size. After the shift, data remaining in the block may be stored in the public storage and data deviating from the block due to the shift may be stored in the security storage medium.

According to another embodiment of the present invention, the data in each block may be shifted only in one direction, or shifted by a predetermined size while maintaining upward, downward, leftward and rightward orientation.

According to another embodiment of the present invention, the original data may be fragmented in one of a half unit, a one-third unit, and a quarter unit.

According to another embodiment of the present invention, the original data may be fragmented into two halves, of which the left-sided values are shifted in a leftward direction, and the right-sided values are shifted in a rightward direction.

According to another embodiment of the present invention, the data in each block may be shifted to a random address by a predetermined size.

According to another embodiment of the present invention, the security storage medium may store shift information for recovering the values that exist within the block and are stored in the public storage and the values that deviate from the block due to the shift and are stored in the security storage medium.

According to another embodiment of the present invention, empty bits unoccupied by remaining values within the block may be filled with values different from the values stored in the bits prior to the shift.

According to another embodiment of the present invention, the empty bits may be filled with any one of a value contrary to the value stored in the bits prior to the shift, an arbitrary value generated randomly, and a value extracted from an arbitrary address.

According to another embodiment of the present invention, the data may be shifted in a predetermined bit or a predetermined address.

### [Advantageous Effects]

According to embodiments of the present invention, the data security apparatus distributes and stores data to prevent computer hacking, and prevents illegal data release caused by an internal user regardless of whether unintentional or intentional, and fuses/recovers the distributed and stored data when called by a authorized user to thereby improve security of the data.

### DESCRIPTION OF DRAWINGS

FIG. 1 is a block diagram illustrating a data security apparatus according to an embodiment of the present invention;

FIG. 2 illustrates the format of fragmented original data according to an embodiment of the present invention;

FIG. 3 illustrates how body blocks and operation key blocks are distributed over and stored in public and security storage medium according to an embodiment of the present invention;

FIG. 4 illustrates how a body is fragmented, randomly blocked, and distributed and stored according to an embodiment of the present invention;

FIG. 5 illustrates how original data is distributed over and stored in public, private, and security storage medium according to an embodiment of the present invention;

FIG. 6 illustrates the format of remaining data after deleting from security storage medium.

FIG. 7 illustrates how GNU (Grab And Union) instruction is stored in security storage medium according to an embodiment of the present invention;

FIG. 8 illustrates how authentication information is distributed and stored according to an embodiment of the present invention;

FIG. 9 illustrates how original data is fragmented into a well structured blocks according to an embodiment of the present invention;

FIG. 10 illustrates how binary data in a block is shifted to the left by two bits, and then is distributed and stored according to an embodiment of the present invention; and

FIG. 11 illustrates how binary data in a block is shifted in both directions by two bits, and then is distributed and stored according to an embodiment of the present invention.

### MODE FOR INVENTION

Reference will now be made in greater detail to exemplary embodiments of the invention, examples of which are illustrated in the accompanying drawings. It should be noted that, wherever possible, the same reference numerals will be used throughout the drawings and the description to refer to the same or like parts.

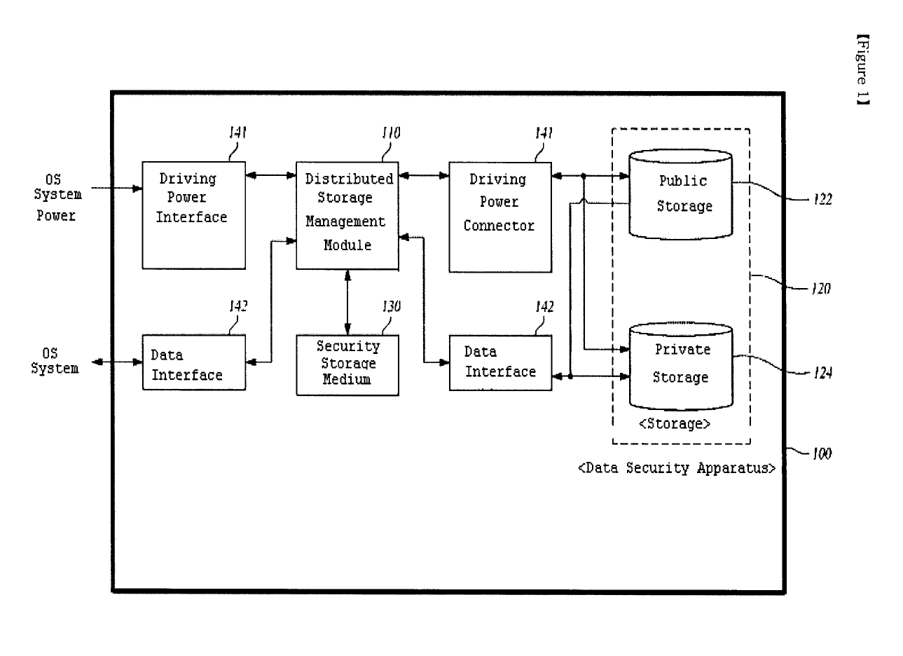

FIG. 1 is a block diagram illustrating a data security apparatus according to an embodiment of the present invention.

A distributed storage management module 110 is a physically embedded unit between an operating system (OS) system and a storage (e.g. a hard disk drive (HDD) or a flash memory), and physically controls a flow of data between the storage and a security storage medium and the OS system, connection between modules, and other related functions. The distributed storage management module 110 takes charge of controls over all physical operations such as connection management between the OS system and the storage media (storage 120 and security storage medium 130), hardware/software destruction of data in the security storage medium when given conditions such as content theft and illegal data release are met, management of the security storage medium used for distributed data security algorithms, authentication tool management for authentication, and so on.

The distributed storage management module 110 controls a data interface 142 and a driving power connector 141 depending on whether or not a user is authenticated, and performs power supply and data interface on each module only when the user is successfully authenticated.

As described above, the hardware/software destruction of data in the security storage medium when given conditions such as content theft, illegal data release, etc. are met means completely destroying the data stored in the security storage medium in a hardware or software fashion.

In detail, when a data hijacking attempt is made or when the given destruction conditions preset by a manager are met, the distributed storage management module 110 completely deletes the distributed data stored in the security storage medium 130 with the distributed data stored in the storage 120 left untouched, or removes a memory function in a hardware (physical) fashion (for example, the memory function is destroyed by applying a voltage exceeding a rated voltage to the security storage medium such as a flash memory), thereby making it impossible for a data hijacker to recover the original data in any way. Such a data hijacking attempt can be monitored by detecting it through a sensor installed around the data security apparatus, or by detecting when an action violating a preset security policy occurs or when the state of data to which security is applied deviates from a preset state.

Further, the distributed storage management module 110 fragments original data of files into data blocks, and distributes and stores the data blocks over and in the storage 120 and the security storage medium 130, fuses the data blocks distributed over and stored in the storage 120 and the security storage medium 130 when the distributed and stored data blocks are called by the OS system, and recovers the original data from the data blocks.

The storage 120 is a region in which the data is stored, and is realized by a storable memory storage medium such as a hard disk, a flash memory, or the like. In an embodiment of the present invention, the storage is generally classified as a public storage 122, to which any one who gets only authentication of the OS system can access, and a private storage 124, to which only an authorized user who gets separate authentication in spite of authentication of the OS system can gain access.

The security storage medium 130 includes any type of storable module that can input and output information such as a flash memory, a compact flash (CF) card, a secure digital (SD) card, a smart media (SM) card, a multi-media (MM) card, a memory stick, and so on, and is installed in the data security apparatus or a separate apparatus.

The security storage medium is called security information storage (SIS), and is a confidential storage space, which is different from the storage and disables even a duly authenticated user from directly accessing the security storage medium.

In other words, even an authorized user who is authenticated from the OS system cannot generally interface data at user's level with the security storage medium 130. When it is necessary to gain access to the security storage medium according to circumstances, the security storage medium can be realized such that the user cannot gain access as long as a special application program interface (API) that is not exposed to the outside is not used.

Meanwhile, the security storage medium 130 fragments the original data into data blocks, and distributes and stores the data blocks together with the storage 120. In the state in which the data blocks are distributed over and stored in the storage 120 and the security storage medium 130, when the given conditions on the data security apparatus 100 are met, the data stored in the security storage medium 130 is completely deleted in a software fashion, or the memory function of the security storage medium 130 is destroyed in a hardware fashion. Thereby, the data stored in the security storage medium 130 is completely removed.

Meanwhile, although the single storage (public storage and private storage) and the single security storage medium are illustrated in the figures, a plurality of storages and security storage media may exist in a computer system, or be distributed over a number of storage spaces (or storage devices).

Further, the storage (public storage and private storage) and the security storage medium may be located in a single storage device (e.g. flash memory, hard disk, etc.) that is physically identical, or be configured of respective storage devices that are physically different from each other.

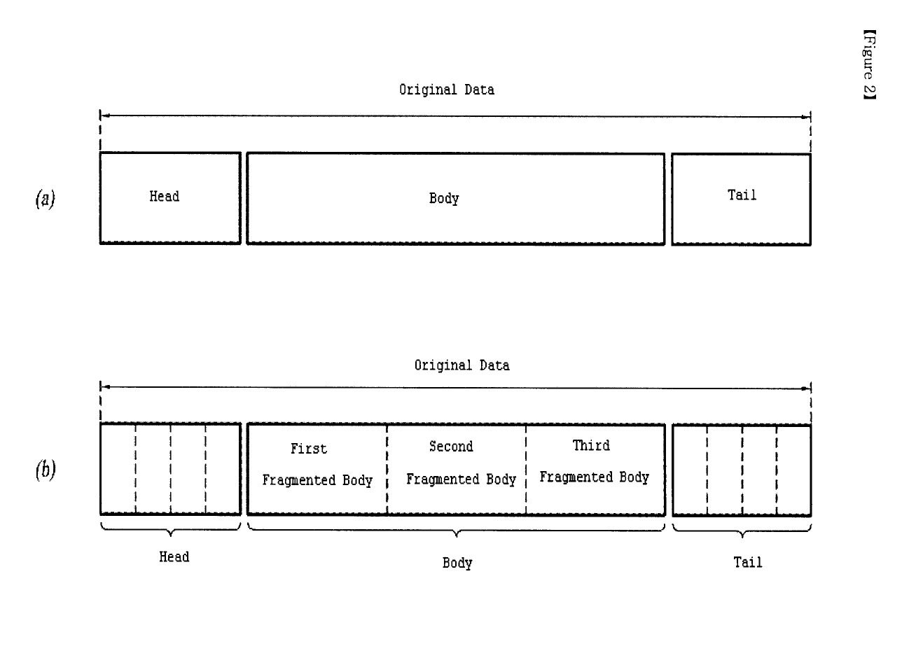

The original data refers to actual data intending for storage, and is illustrated in FIG. 2(a).

Generally, any file includes body information in which detail contents thereof are recorded, and head information and tail information in which information and definition about the corresponding file is recorded. In an embodiment of the present invention, information including the head information and the tail information is defined as an operation key.

The operation key stores file information such as filename extension, creator, type, date created, date modified, size, and other attributes in binary format. Further, the operation key includes authentication call information that calls authentication information for user authentication for the corresponding file.

In an embodiment of the present invention, as illustrated in FIG. 2(b), the body is fragmented into a plurality of sub-bodies, which is distributed over and stored in the security storage medium and the storage. In addition, the operation key is also extracted, and is fragmented into random blocks, which are distributed over and stored in the security storage medium and the storage. For example, among the random blocks into which the entire body is fragmented, a first body block is stored in the storage, and the other blocks, i.e. the second body blocks are stored in the security storage medium. Similarly, among the random blocks into which the operation key is fragmented, a first operation key block is stored in the storage, and the other blocks, i.e. the second operation key blocks are stored in the security storage medium. In this manner, the data fragmented, distributed and stored is brought together again by an authenticated person, and has one piece of complete information.

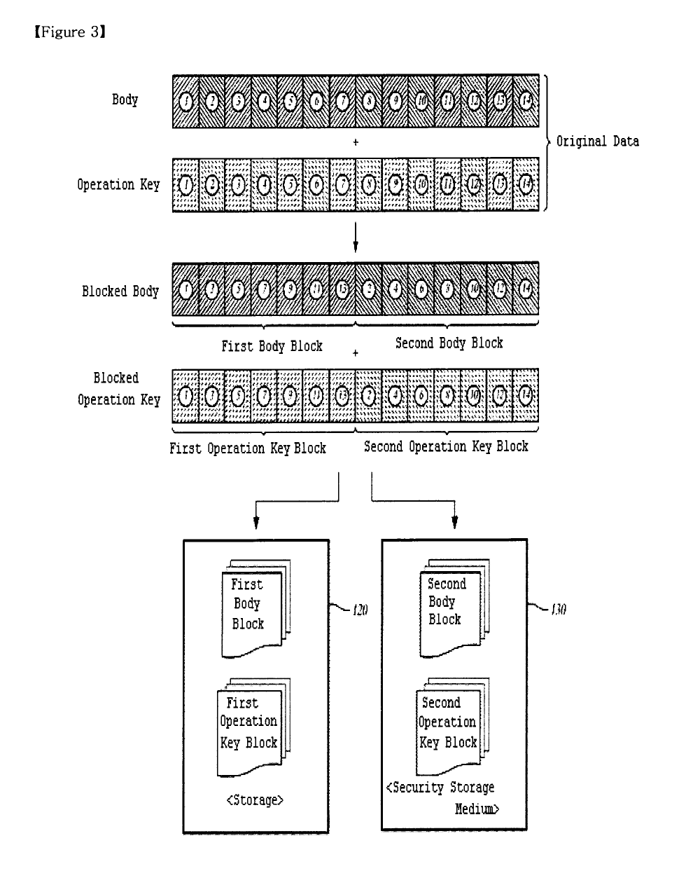

Referring to the format of the data distributed and stored in greater detail, as illustrated in FIG. 3, the original data including the body of the file intending for protection and the operation key containing the information about this file is fragmented into a plurality of random data blocks (e.g. two blocks in FIG. 3), which is distributed over and stored in the storage 120 and the security storage medium 130.

Referring to FIG. 3, for example, the body is fragmented into 14 body pieces. Among them, the odd body pieces are blocked into a first body block, and the even pieces are blocked into a second body block. The first body block is stored in the storage 120, and the second body block is stored in the security storage medium 130. Similarly, the operation key is fragmented into 14 operation key pieces. Among them, the odd operation key pieces are blocked into a first operation key block, and the even operation key pieces are blocked into a second operation key block. The first operation key block is stored in the storage 120, and the second operation key block is stored in the security storage medium 130.

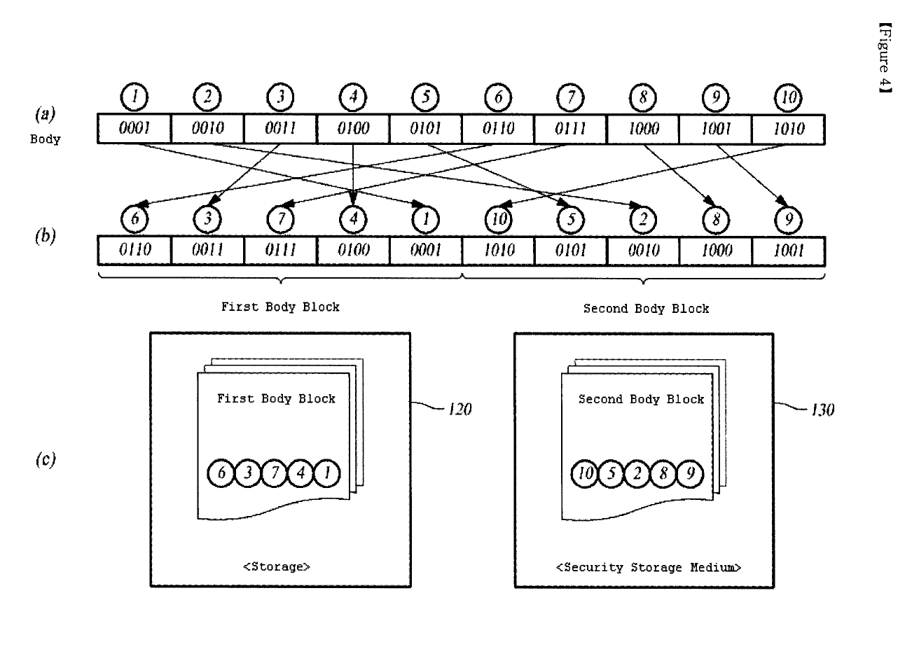

However, in FIG. 3, the format of the data fragmented and blocked shows that the even and odd pieces are uniformly grouped and blocked. Actually, the fragmented data pieces can be randomly blocked, and then be distributed and stored. In an embodiment of the present invention, an example in which the data pieces are actually distributed and stored is illustrated in FIG. 4. For example, the body of the original data is fragmented into a plurality of body pieces as in FIG. 4(a), and then these fragmented body pieces are randomly blocked into body blocks as in FIG. 4(b). Subsequently, the body blocks are distributed over and stored in the storage 120 and the security storage medium 130 as in FIG. 4(c). In the case of the original data of FIG. 4, only the format of the body distributed and stored is illustrated. However, the operation key is also fragmented, is randomly blocked, and is distributed over and stored in the storage and the security storage medium.

Meanwhile, as described above, the storage in the computer security system includes a public storage region that is accessible after any user gets basic system authentication (primary authentication), a private storage region that is recognizable and accessible only after even a primarily authenticated user goes through separate authentication (secondary authentication, and if necessary, additional authentication procedures such as tertiary authentication, quaternary authentication, etc.), and a security storage medium that cannot be recognized with respect to physical location as well as its internal contents by even a normal user who gets actual access to the data to which the basic system authentication and security are applied and successfully goes through the separate authentication procedures for use.

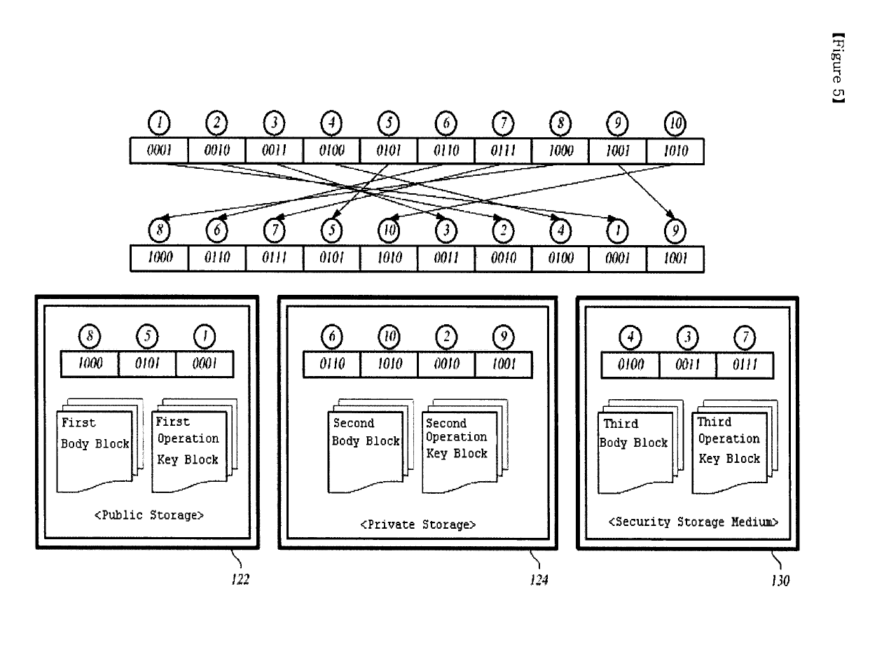

Thus, FIG. 3 shows a structure in which the original data (body and operation key) is distributed over and stored in two storages, i.e. the storage 120 and the security storage medium 130. In another embodiment of the present invention, the original data can be realized such that it is randomly blocked and then is distributed over and stored in three storages, the public storage 122, the private storage 124, and the security storage medium 130. FIG. 5 shows a structure in which the original data is distributed over and stored in the public storage, the private storage, and the security storage medium.

The following description will be made on the assumption that the original data is distributed over and stored in generic components, i.e. the storage 120 and the security storage medium 130. However, it will be apparent that the original data can be distributed over and stored in the public storage 122, the private storage 124, and the security storage medium 130 according to another embodiment of the present invention.

Under the distributed and stored structure as described above, when the data hijacking attempt is made or when the given conditions are met, the memory function of the security storage medium is completely deleted in a software fashion or is destroyed in a hardware (physical) fashion, so that only the distributed data stored in the security storage medium 130 is removed. In this case, since only the distributed data stored in the storage 120 are insignificant data, the data cannot be completely recovered to the original data even using any method. This is because, without the distributed data stored in the security storage medium 130, the distributed data stored in the other storage have no relation. Thus, without the distributed data (second block) stored in the security storage medium 130, the distributed data (first block) stored in the storage is merely insignificant data.

In other words, without the distributed data stored in the security storage medium 130, the distributed data stored in the other storage becomes completely different from the original data, and thus is merely insignificant data.

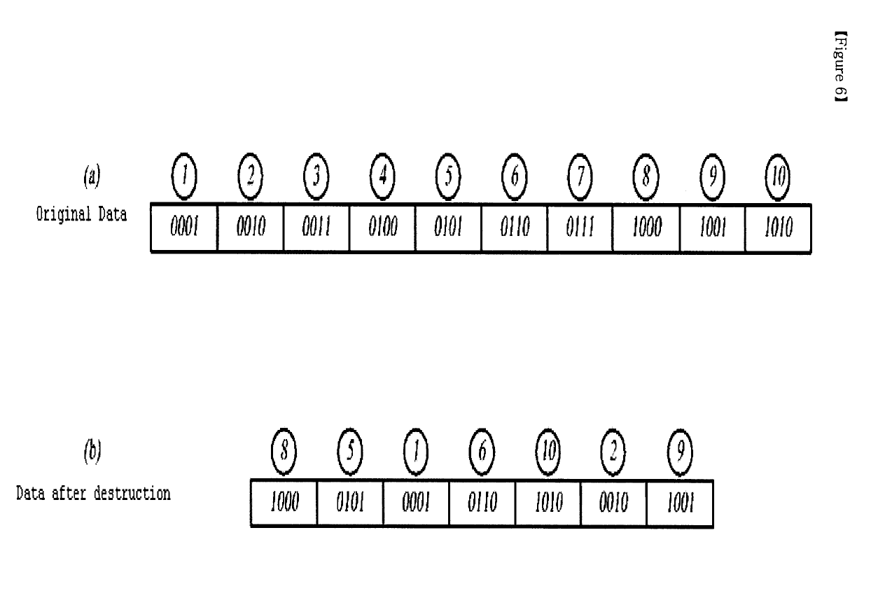

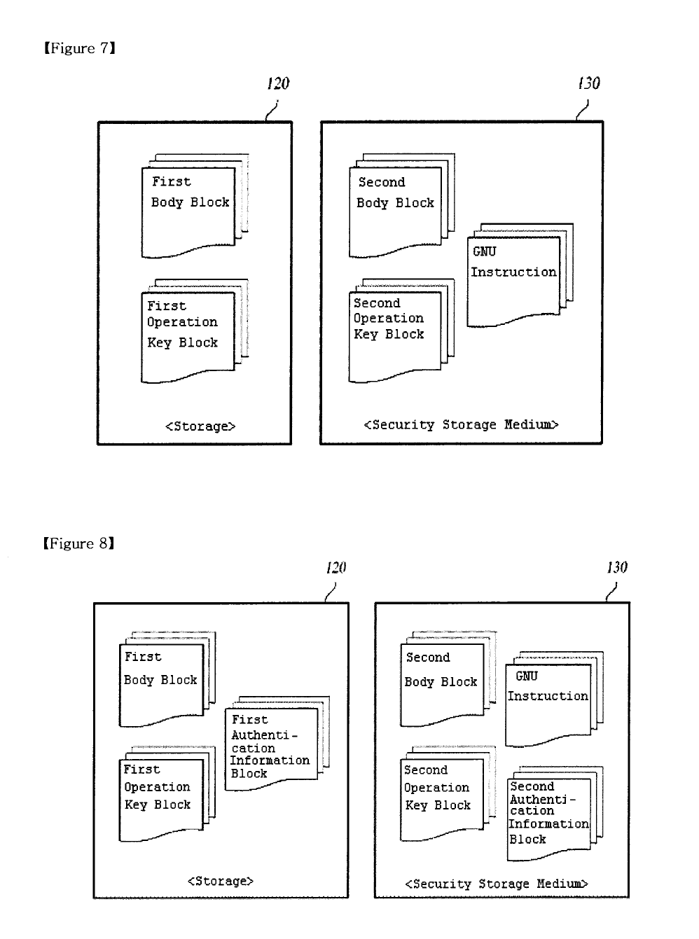

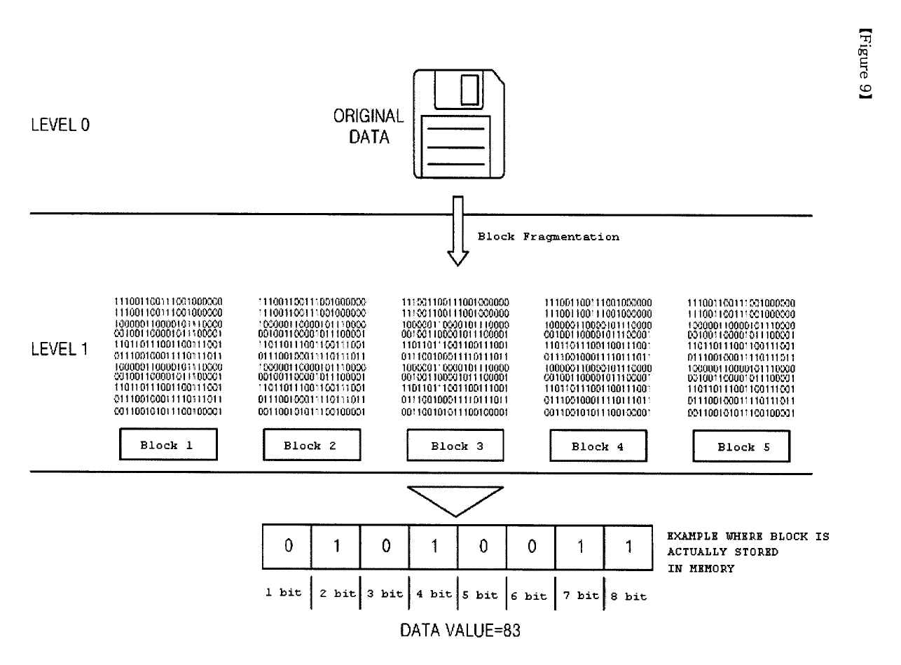

As illustrated in FIG. 6, it is assumed that the original data has a format as illustrated in FIG. 6(a), and that it is distributed over and stored in the public storage 122, the private storage 124 and the security storage medium 130. If the memory function of the security storage medium 130 is completely deleted in a software fashion or is destroyed in a hardware (physical) fashion, only the data of the public storage and the private storage are left as in FIG. 6(b), and thus become merely insignificant data.

Meanwhile, what the distributed data stored in the security storage medium 130 is completely deleted in a software fashion means deleting the distributed data stored in the memory of the security storage medium 130 using a delete function of the security storage medium 130 itself without any help from the operating system so as to be permanently disabled to be recovered, without storing the distributed data in the storage (public storage and private storage) of which the operating system takes charge. For example, only a part of the data stored in the security storage medium 130 is randomly deleted or forcibly shifted in a sequence stored in the memory according to an address of the memory, thereby making the data insignificant. Then, the insignificant data is deleted. This operation is repeated to make the data stored in the security storage medium completely insignificant.

Further, what the distributed data stored in the security storage medium 130 is physically destroyed means physically destroying the memory function of the security storage medium so as to be permanently disabled to be recovered. For example, in the case in which the security storage medium 130 is implemented as a flash memory, the physical destruction of the memory function does not mean deleting the data in the flash memory, but applying power higher than rated power (e.g. rated current or rated voltage) permitted on the specification of the flash memory to the flash memory to thereby completely destroy the memory function of the flash memory.

In order to generate the power higher than the allowable rated power of the security storage medium, a corresponding level of power can be supplied from an external OS system, and then be applied to the security storage medium. Further, as another embodiment, the data security apparatus itself is equipped with a battery (not shown) capable of generating the power higher than the allowable rated power of the security storage medium. When a destruction instruction requested to destroy all data in the security storage medium is generated from the distributed storage management module, the power of the battery is switched so as to flow through the security storage medium, thereby destroying the memory function of the security storage medium 130.

Meanwhile, as described above, assuming that the original data (body and operation key) is fragmented, randomly blocked, and distributed over and stored in the storage 120 and the security storage medium 130, the distributed data can be called and fused again in future. To this end, an instruction for fusing the distributed data using information about the distributed data is required. In detail, in order to use the distributed and stored data in an effective and convenient way, the due request of an authenticated user is made along with information about how the data is fragmented and stored with respect to each file. At this time, the distributed data are collected and fused, and then the authenticated user can duly use the fused data. To do so, a grab and union (GNU) instruction is required.

The GNU instruction is a kind of sub-program, includes distributed information such as a storage path and a storage location, a fusion instruction, and so on along with information about each data block, and is an instruction to collect and fuse the distributed and stored data. Owing to this instruction, the data blocks distributed over and stored in the storage and the security storage medium are fused into one, thereby recovering the original data.

To this end, when specific files are distributed over and stored in the storage 120 and the security storage medium 130, the distributed information including the storage path and the storage location along with the information about each data block is stored in the security storage medium as the GNU instruction along with the fusion instruction.

As illustrated in FIG. 7, the GNU instruction is stored in the security storage medium 130 along with the distributed data. Thus, when a specific file is called from the OS system by user's request, the GNU instruction of the corresponding file is read out of the security storage medium 130, and then is executed. The GNU instruction reads out of the fragmented data that are distributed and stored using the distributed information contained in itself, and recovers the original data from the fragmented data.

Accordingly, when the OS system calls the specific file, the GNU instruction associated with the corresponding file is called first. In detail, when the specific file is called, the OS system has to read out an address of the GNU instruction stored in the security storage medium 130, and to execute the GNU instruction. When the OS system intends to call the specific file, the corresponding files are distributed and stored, and thus can be directly read out. For this reason, the OS system reads out the address of the GNU instruction associated with the corresponding file, and then executes the GNU instruction. In view of the structure of the OS system, the address of the GNU instruction is stored along with the corresponding file to be called, and thus can be called by the OS system.

Further, the entire GNU instruction can be stored in the security storage medium as illustrated in FIG. 7. However, in another embodiment of the present invention, the GNU instruction may be distributed over and stored in the storage 120 and the security storage medium 130.

Meanwhile, the fragmented data that are distributed and stored are allowed to be called only by an authenticated user, and thereby to be recovered as the original data. To this end, information about the authentication is required. The authentication information is also fragmented, is randomly blocked, and is distributed over and stored in the storage 120 and the security storage medium 130 as first authentication information and second authentication information. The authentication information for calling the authentication information exists in the operation key along with the file information.

The authentication information includes environmental information about the storage, environmental information about the system, environmental information about work environment, environmental information about the file itself, environmental information for identifying the user, and so on. Only when all pieces of information are properly matched, it can be determined that the authentication is successfully completed. The environmental information about the storage includes hardware information about the storage in the corresponding data security apparatus. The environmental information about the system includes a CPU version of the system communicating with the corresponding data security apparatus, an OS version, information about various pieces of hardware and software constituting the system, and so on. The environmental information about work environment includes network accessible IP, server information, information about software and hardware of the server, information about input and output units and various systems connected to the network, information about a user, and so on. The environmental information about the file itself includes accessible password contained in a file, information about various definitions and authorities of the file, information about a user and his/her authority related to the file, and so on. The environmental information for identifying the user refers to digital information such as various pieces of information for identifying the user such as a user identifier (ID), a password, biometric information (fingerprint, iris, etc.), voice recognition, etc., and information about the user authorities.

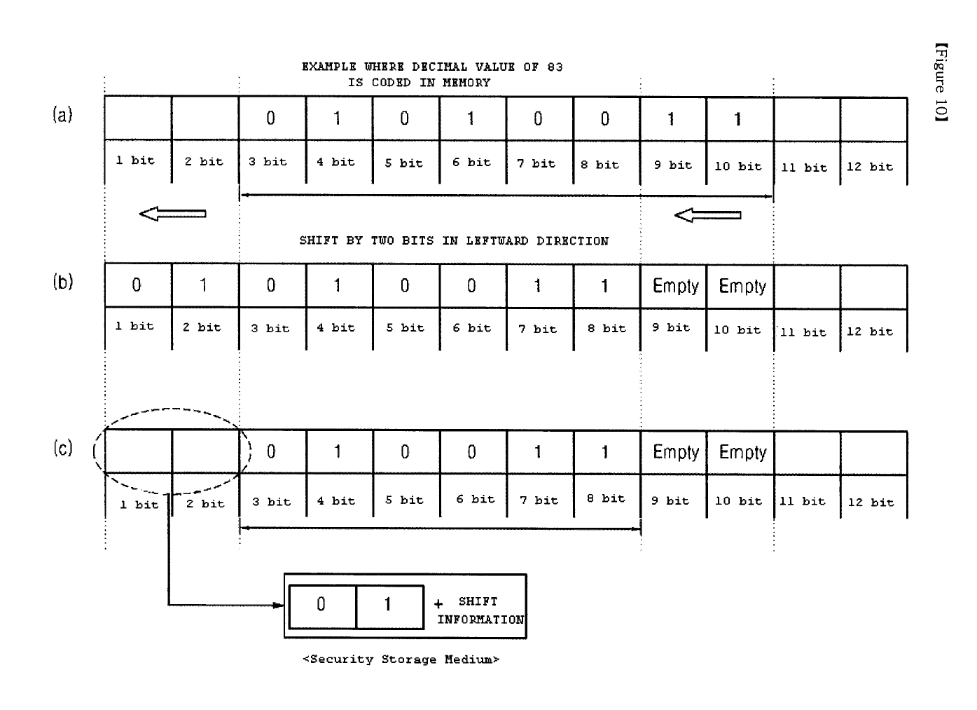

Meanwhile, referring to FIG. 4, the fragmented blocks are distributed over and stored in the storage 120 and the security storage medium 130. Referring to FIG. 5, the fragmented blocks are distributed over and stored in the public storage 122, the private storage 124, and the security storage medium 130. In other words, as illustrated in FIG. 9, the original data contained in one file is fragmented into numerous blocks, which are distributed over and stored in the respective storages.

As described above, the original data (first level) is fragmented into a plurality of blocks (second level), and the plurality of blocks are distributed and stored. In another embodiment of the present invention, the original data may be fragmented into a plurality of blocks, and binary data in the fragmented blocks are shifted. Then, a part of the binary data (third level) may be distributed over and stored in the security storage medium 130.

In detail, binary values in the block are shifted by a predetermined size. After the shift, data remaining within a range of the block prior to the shift are stored in the storage 120, while data beyond a range of the block are stored in the security storage medium 130.

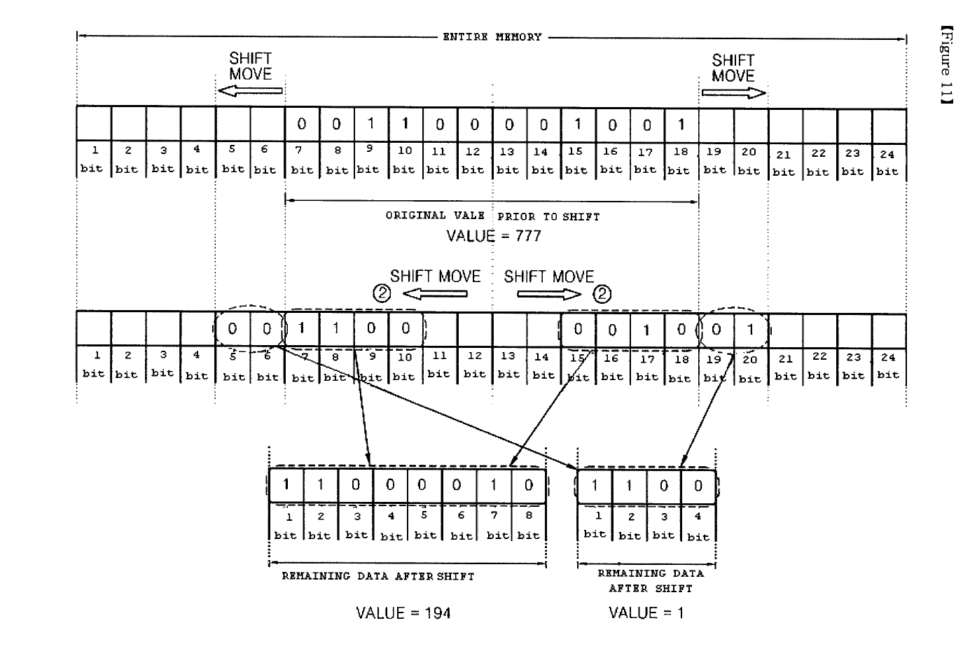

An example of distributing and storing the fragmented block having a binary value of ‘01010011’ corresponding to a decimal value of ‘83’ as illustrated in FIG. 9, In another embodiment of the present invention will be described with reference to FIG. 10.

In the ‘01010011’ block of FIG. 10(a), a part stored in the storage 120 is remaining data within a first block range by the shift, and a part stored in the security storage medium 130 is data beyond a first block range by the shift.

More specifically, when the binary value of ‘01010011’ of FIG. 10(a) is shifted by two bits in a leftward direction as in FIG. 10(b), the value stored in the storage 120 becomes ‘010011’ that is a value within the first block range, and two bits of ‘10’ of a first part is shifted leftwards, and thus deviates from the first block range.

Thus, the value of ‘010011’ is stored in the storage 120 due to two-bit leftward shift of the binary in the block, and the other two bits of the first part deviating from the block range due to the shift is stored in the security storage medium 130.

The information stored in the security storage medium 130 includes shift information for recovering and reversely shifting in future (e.g. shifting two bits in a leftward direction), in addition to the two bits of the first part deviating from the storage range due to the shift.

Meanwhile, the data can be shifted, distributed and stored in various ways on the basis of the shift.

As an embodiment of the shift, the data can be distributed and stored by the shift having upward, downward, leftward, and rightward orientation. For example, the data are distributed and stored through a uni-directional shift as illustrated in FIG. 10(c), or through a bi-directional shift as illustrated in FIG. 11. The shift having the orientation is not limited to the leftward and rightward directions as illustrated in FIGS. 10(c) and 11. Thus, the data can be shifted in upward and downward directions, and then be distributed and stored according to a storage medium type or a storage mode.

Further, as another embodiment of the shift, a part of data can be shifted using a specific address value secured randomly, and then be distributed and stored according to a storage medium type or a storage mode.

For reference, the case of shifting the data in both directions rather than in one direction and then distributing and storing the data in the block will be described with reference to FIG. 11. A binary value of ‘001100001001’ is divided into two halves. The left-sided binary value of ‘001100’ is shifted to the left by two bits, and the right-side binary value of ‘001001’ is shifted to the right by two bits. After the shift, the remaining values within a block range prior to the shift are summed up, and are stored in the storage 120 as a binary value of ‘11000010’ (decimal value of 194). As a result of the shift, the remaining values deviating from the block range prior to the shift are summed up, and are stored in the security storage medium 130 as a binary value of ‘0001’ decimal value of 1).

In the embodiment of FIG. 11, the data is divided into two halves, and then is shifted in both directions. This embodiment is merely illustrative. The data may be divided into various units such as a one-third unit, a quarter unit, etc., be shifted in upward, downward, leftward and rightward directions, and then be distributed and stored.

Meanwhile, after the uni-directional shift, the bi-directional shift, and the shift to a random specific address, the empty bites except the remaining bits within the block range prior to the shift are neglected as they stand. For example, as illustrated in FIG. 10(c), the data stored in the storage 120 after the shift becomes a value of ‘010011’ (decimal value of 19) that corresponds to the remaining data within the first block range.

In this manner, after the uni-directional shift, the bi-directional shift, and the shift to a random specific address, the empty bites other than the remaining bits within the block range prior to the shift are neglected to store data. However, as another embodiment of the present invention, values different from the values stored in the respective bites prior to the shift may be filled, so that the values of the original data may be changed into completely different values.

This means that, after the shift, values that are quite contrary to original values are stored in the empty address within the block range prior to the shift, thereby changing the values of the original data into completely different values. For example, if a value of the original bit is 1 or 0, it is changed into the contrary value of 0 or 1. Further, the original bit is filled with an arbitrary value generated randomly, or a value extracted from an arbitrary address. Thereby, the values of the original data are changed into completely different values.

Referring to FIG. 10, when two bits are shifted to the left, 9-th and 10-th bites having a value of ‘1’ prior to the shift becomes a null state having no value. The empty 9-th and 10-th bites after the shift are filled with a value of ‘00’ that is contrary to the original value of ‘11’ an arbitrary value generated randomly, or a value extracted from an arbitrary address.

For example, in FIG. 10(c), in the case in which the empty bits after the shift are filled with the value of ‘00’ that is contrary to the original value of ‘11’ a value of ‘01001100 ’ (decimal value of 76) is stored in the storage.

As described above, when the values of the original data are changed into completely different values by filling the corresponding bits prior to the shift with values different from the stored values, information about the filled values, i.e. shift information, is required to recover the original values from the changed values in future.

In detail, the shift information includes information about the shifted size, and information about whether or not the empty bits after the shift are left without a change. If the empty bits are filled with different values, the shift information includes information about the filled values. This is required when the distributed data are recovered and fused again.

Meanwhile, the description above is made of the example in which the data is shifted in a bit. As another embodiment of the present invention, the data may be shifted in an address. In other words, the description above is made of the example in which the binary data is shifted in a bit. However, the data may be shifted in an address consisting of 8 bits or 16 bits.

Although exemplary embodiments of the present invention have been described for illustrative purposes, those skilled in the art will appreciate that various modifications, additions and substitutions are possible, without departing from the scope and spirit of the invention as disclosed in the accompanying claims. Thus, such modifications, additions and substitutions should be interpreted as falling into the claims of the present invention.

1. A data security apparatus comprising:
a storage in which a first block of fragmented original data is distributed and stored;
a security storage medium in which a second block of the fragmented original data is distributed and stored; and
a distributed storage management module performing data interface among the storage, the security medium, and an operating system, fragmenting and blocking the original data, and distributing and storing the blocked data over and in the storage and the security storage medium.

2. The data security apparatus according to claim 1, wherein the storage includes:
a public storage that is accessible only with system authentication of the operating system; and
a private storage that is accessible after separate authentication is individually performed by an authentication key.

3. The data security apparatus according to claim 1, wherein the distributed storage management module destroys the data in the security storage medium in a hardware or software fashion when given conditions including at least one of content theft and illegal data release are met.

4. The data security apparatus according to claim 1, wherein the security storage medium disables a user to be directly accessed to perform the data interface.

5. The data security apparatus according to claim 1, wherein the storage and the security storage medium are distributed in a computer system or over a network.

6. The data security apparatus according to claim 1, wherein the original data is fragmented into well structured data blocks, so as to be randomly blocked into at least two blocks, which are distributed over and stored in the storage and the security storage medium.

7. The data security apparatus according to claim 1, wherein the original data includes a body as actual data of a file, and an operation key containing information about the file.

8. The data security apparatus according to claim 7, wherein the body is fragmented into well structured blocks of body so as to be randomly blocked into body blocks, which are distributed over and stored in the storage, the security storage medium and the operation key is fragmented into well structured operation keys, so as to be randomly blocked into operation key blocks, which are distributed over and stored in the storage and the security storage medium.

9. The data security apparatus according to claim 8, wherein authentication information for authenticating a user with respect to the corresponding file is fragmented into numerous pieces of authentication information so as to be randomly blocked into authentication information blocks, which are distributed over and stored in the storage and the security storage medium.

10. The data security apparatus according to claim 7, wherein the file contained in the operation key includes information about filename extension, creator, type, data created, date modified, size, attributes thereof, and authentication information for calling authentication information for authenticating a user with respect to the corresponding file.

11. The data security apparatus according to claim 9, wherein the authentication information includes environment information about the storage, environment information about the system, environment information about work environment, environment information about the file itself, environment information for identifying a user.

12. The data security apparatus according to claim 1, wherein the security storage medium further includes a grab and union instruction having a storage path, a storage location, and a fusion instruction of each block when the file is blocked and is distributed and stored in the storage and'the security storage medium.

13. The data security apparatus according to claim 12, wherein the distributed storage management module executes the grab and union instruction when the file is called, so as to fuse the related fragmented data distributed and stored in the storage and the security storage medium and recover the original data from the fragmented data.

14. The data security apparatus according to claim 1, wherein the data in each block is shifted by a predetermined size, and after the shift data remaining in the block are stored in the public storage and data deviating from the block due the shift are stored in the security storage medium.

15. The data security apparatus according to claim 14, wherein the data in each block is shifted by a predetermined size while maintaining upward, downward, leftward and rightward orientation.

16. The data security apparatus according to claim 15, wherein the data in each block is shifted only in one direction.

17. The data security apparatus according to claim 15, wherein the original data is fragmented into well structured blocks so as to be shifted by a predetermined size, while maintaining upward, downward, leftward and rightward orientation.

18. The data security apparatus according to claim 17, wherein the original data is fragmented in one of a half unit, a one-third unit, and a quarter unit.

19. The data security apparatus according to claim 18, wherein the original data is fragmented into two halves, of which the left-sided values are shifted in a leftward direction, and the right-sided values are shifted in a rightward direction.

20. The data security apparatus according to claim 14, wherein the data in each block is shifted to a random address by a predetermined size.

21. The data security apparatus according to claim 15, wherein the security storage medium stores shift information for recovering the values that exist within the block stored in the public storage and the values that deviated from the block due to the shift stored in the security storage medium.

22. The data security apparatus according to claim 14, wherein empty bits unoccupied by remaining values within the block are filled with values different from the values stored in the bits prior to the shift.

23. The data security apparatus according to claim 22, wherein the empty bits are filled with any one of a value contrary to the value stored in the bits prior to the shift, an arbitrary value generated randomly, and a value extracted from an arbitrary address.

24. The data security apparatus according to claim 14, wherein the data is shifted in a predetermined bit or a predetermined address.

25. The data security apparatus according to claim 10, wherein the authentication information includes environment information about the storage, environment information about the system, environment information about work environment, environment information about the file itself, environment information for identifying a user.

26. The data security apparatus according to claim 20, wherein the security storage medium stores shift information for recovering the values that exist within the block stored in the public storage and the values that deviated from the block due to the shift stored in the security storage medium.
